(19) United States
(12) Patent Application Publication
(10) Pub. No.: US 2017/0287580 A1
(43) Pub. Date: Oct. 5, 2017

(54) LIQUID GALLIUM COOLED HIGH CURRENT ACCELERATOR TARGET

(71) Applicant: Robert John Ylimaki, Moseley, VA (US)

(72) Inventor: Robert John Ylimaki, Moseley, VA (US)

(21) Appl. No.: 15/084,953

(22) Filed: Mar. 30, 2016

(51) Int. Cl. G21G 1/04

(52) U.S. Cl. CPC G21G 1/04

(57) ABSTRACT

Radioisotopes are produced by irradiating enriched stable isotopes in a particle accelerator target assembly with a beam of protons, deuterons, or other charged particles exhibiting sufficient incident energy and current to induce a nuclear reaction. The target assembly receives a recirculating flow of liquid gallium to remove heat flux that would damage the target assembly when operated with high intensity beam currents. The choice of liquid gallium and its eutectic alloys, all liquids at room temperature, over prior art working fluids for the coolant system is advantageous by providing significantly increased heat transfer to prevent target damage, minimizing enriched material losses, thereby decreasing production costs, and realizing greater radioisotope output.

### BACKGROUND OF THE INVENTION

The present invention is in the technical field of radioisotope production using a particle accelerator. More particularly, the present invention is in the technical field of accelerator targets capable of irradiating solid phase, low thermal conductivity, enriched stable isotopes with a high-intensity beam of protons, deuterons, or other charged particles to induce nuclear transmutation.

Accelerator target systems used in the production of radioisotopes using high-intensity particle beams can be susceptible to vapor pressure losses of expensive enriched materials due to inadequate cooling system removal of the incident heat flux. An example of such a susceptible stable isotope is the ¹²⁴Te enriched TeO₂ matrix used for the production of ¹²⁴I via the proton-neutron exchange reaction ¹²⁴Te(p,n)¹²⁴I. This matrix exhibits low thermal conductivity, and the Bragg peak occurs at four-fifths of the matrix depth, close to the target backing plate, near the flow of the coolant system working fluid. Consequently, eighty percent of the heat load is removed by the liquid coolant. Heat transfer via the coolant system working fluid becomes paramount to avoiding expensive enriched material losses due to vapor pressure during target bombardment using high current proton beams in this example.

### BRIEF SUMMARY OF THE INVENTION

The present invention is an accelerator-based radioisotope target that includes solid phase stable isotope material that is bombarded by an incident particle beam. The heat from the target is removed by a cooling loop incorporating liquid gallium or its eutectic alloys, all of which are liquids at room temperature, as the working fluid.

The flow of gallium is controlled to allow high intensity beam currents to be achieved, typically twice that of water cooling, without target damage to the solid phase low thermal conductivity target matrix.

### BRIEF DESCRIPTION OF THE DRAWINGS

FIG. 1 is a functional line diagram of a liquid gallium cooled radioisotope target.

FIG. 2 is a cross sectional view of the irradiation chamber and coolant flow path of the accelerator-based radioisotope target.

### DETAILED DESCRIPTION OF THE INVENTION

According to the present invention, an accelerator-based radioisotope target includes stable isotope material that is bombarded by an incident particle beam. The heat from the target is removed by a cooling loop incorporating liquid gallium or its eutectic alloys as the working fluid. The flow of gallium is controlled to allow high incident beam currents to be achieved without target damage.

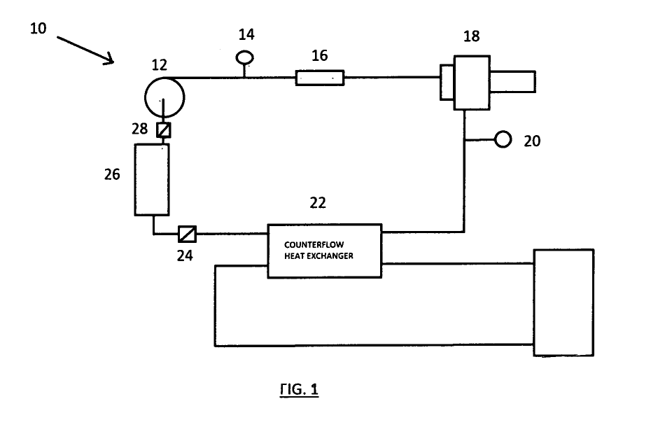

Referring now to the invention in more detail, FIG.1 is a functional block diagram illustration of a liquid gallium cooled high current accelerator target system 10. The system is comprised of an accelerator target 18 that includes a stable isotope target matrix (not shown). The target permits bombardment of a stable isotope target matrix by an incident charged particle beam, which may be for example protons or deuterons, to induce nuclear reactions that result in the production of radioisotopes.

The cooling system 10 depicted incorporates a liquid gallium surge volume in a tank reservoir 26 to maintain system pressure. The system overcomes head losses to maintain flow circulation by incorporating a centrifugal pump 12. System instrumentation include system flow 16 and pressure sensors 14, 20 and indicators. These permit operator monitoring of system conditions. The liquid gallium working fluid flow path is from the pump discharge through the pressure sensor then flow sensor, both connected to remote indicators of their respective operating parameters for monitoring and control. The liquid gallium working fluid flows from the accelerator radioisotope target 18 to a counter-flow heat exchanger which rejects heat to an external heat sink (not shown). Check valves 24, 28 in the coolant loop on the outlet and inlet of the reservoir surge volume prevent backflow.

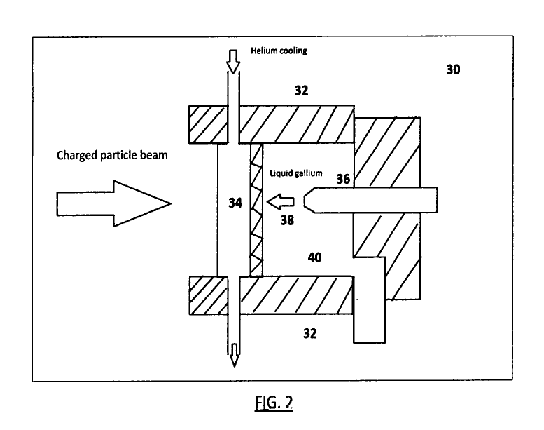

FIG. 2 is a cross-sectional illustration of a portion of an accelerator-based radioisotope production target 18 (FIG. 1). The target 18 (FIG. 1) is comprised of a stainless steel body within which the enriched material target 34, having a first surface 34 of target matrix bombarded by an energetic charged particle beam, which for example may be protons or deuterons. The incident charged particle beam induces nuclear reactions, and the enriched material target 34 becomes heated to temperatures approaching 600° C. Accordingly, the present invention cools the target second surface 38 using a pressurized stream of liquid gallium.

The target 18 includes a convergent nozzle 36 that directs the flow of liquid gallium onto the second surface 38 of the target 18. The liquid gallium cavity 40 directs the flow to a low pressure side exit to the heat exchanger 22.

Highly significant, by employing liquid gallium or its eutectic alloys as the system working fluid in the cooling system for a radioisotope production target is that operation under extremely high currents, i.e. exceeding 500 micro-amps (μA) continuous-wave (CW) is permitted without comparable loss of cooling efficacy as would be the case under conventional water cooling. Heat fluxes exceeding 15-20 MW/m² cannot be removed reliably using water cooling, as they are typically beyond the critical heat flux (CHF) of water in conventional accelerator cooling systems. Nearing the CHF limit, heat removal must occur using forced convective boiling, demanding very high water jet velocities (>20 m/s) and flow rates (>75 GPM). These flow rates demand high power ratings on the pumps and operate perilously close to the CHF limit. Catastrophic failure can result in loss of expensive enriched materials, as well as release of radioactivity from the target matrix first surface 34 into the helium cooling system with resultant radioactive contamination.

As a liquid metal, gallium exhibits thermal conductivity a factor of fifty (50) times greater than water. The effectiveness of liquid gallium as a cooling system working fluid was verified by conducting experiments using an 18 MeV negative ion (H⁻) compact medical cyclotron. Target power loadings from zero to 1 kW were used to heat a blank target disk cooled with water or liquid gallium. The size of the beam was measured using a dummy target capable of imprinting a beam spot by a paper burn mark. Temperature measurements were made and the MATLAB program used to determine the respective mean thermal conductivities. CHF failure of the water cooled disk occurred, as well as target damage due to failure of the Kalrez compound 7075 O-ring seals.

The advantages of the present invention include, without limitation, that no target system failures occurred with gallium or its commercially available eutectic alloys as the coolant system working fluid. Given equal flow rates, as the system working fluid gallium substantially improved heat transfer at the target interface, lowering temperatures by 33% over water cooling, with impressive linearity over the range of temperatures. CHF is not a concern with gallium, as its boiling point is an impressive 2205° C. Large heat flux removal with no likelihood of exceeding CHF limits, even at low flow rates, make gallium preferable over other liquid metal coolants like sodium, which is highly reactive chemically.

Toxicity is a concern when producing radiochemical products which will undergo further manufacturing into radiopharmaceuticals, and to its further advantage, gallium is non-toxic.

While the foregoing written desciiplion of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of cooling an accelerator radioisotope target assembly, comprising:
A surge tank of liquid gallium, or its eutectic alloys;
A centrifugal circulating pump;
A convergent nozzle, said nozzle providing a pressurized jet of gallium liquid in a direction normal to the non-irradiated surface of the target material within the target assembly;
A heat exchanger; and
Means for circulating in series fashion said liquid gallium from said surge tank through said convergent nozzle to flow turbulently upon said surface of the target disk within the radioisotope target assembly, from the radioisotope target assembly to said heat exchanger, and from said heat exchanger to said surge tank.

2. The method of claim 1, wherein the target material comprises ¹²⁴Te enriched tellurium oxide.

3. A liquid cooling system for a radioisotope target assembly, said cooling system comprising:
A surge tank of liquid gallium, or its eutectic alloys;
A centrifugal circulating pump;
A convergent nozzle, said nozzle providing a pressurized jet of gallium liquid in a direction normal to the non-irradiated surface of the target material within the target assembly;
A heat exchanger; and
Means for circulating in series fashion said liquid gallium from said surge tank through said convergent nozzle to flow turbulently upon said surface of the target disk within the radioisotope target assembly, from the radioisotope target assembly to said heat exchanger, and from said heat exchanger to said surge tank.
